(19) United States
(12) Patent Application Publication
(10) Pub. No.: US 2017/0325582 A1
(43) Pub. Date: Nov. 16, 2017

(54) MODULAR COUNTERTOP SYSTEM

(71) Applicants: Jeremy Mort, Gig Harbor, WA (US); Chris Corrigan, Seattle, WA (US)

(72) Inventors: Jeremy Mort, Gig Harbor, WA (US); Chris Corrigan, Seattle, WA (US)

(21) Appl. No.: 15/266,146

(22) Filed: Sep. 15, 2016

Related U.S. Application Data
(63) Continuation-in-part of application No. 15/234,936, filed on Aug. 11, 2016, now abandoned.
(60) Provisional application No. 62/337,277, filed on May 16, 2016.
(60) Provisional application No. 62/348,813, filed on Jun. 10, 2016.
(60) Provisional application No. 62/356,730, filed on Jun. 30, 2016.

(51) Int. Cl. A47B 13/08; F16B 1/00; F16B 12/00

(52) U.S. Cl. CPC A47B 13/088; F16B 12/00; A47B 13/086; F16B 1/00; F16B 2001/0035

(57) ABSTRACT

This invention relates generally to a modular countertop system. In one embodiment, a countertop system includes, but is not limited to, a first countertop section composed of a foam core at least partly covered by a laminate layer; a plurality of interconnection receptacles embedded within the foam core; and a plurality of cut-line indications on a bottom surface of the first countertop section at positions that correspond to the plurality of interconnection receptacles embedded within the foam core, wherein cutting of the first countertop section along any of the plurality of cut-line indications exposes at least one of the plurality of interconnection receptacles.

### PRIORITY CLAIM

This application is a non-provisional application of U.S. provisional patent application Ser. No. 62/337,277 filed May 16, 2016; U.S. provisional patent application Ser. No. 62/348,813 filed Jun. 10, 2016; and U.S. provisional patent application Ser. No. 62/356,730 filed Jun. 30, 2016.

This application is a continuation-in-part of U.S. non-provisional patent application Ser. No. 15/234,936 filed Aug. 11, 2016.

Applicant claims the benefit of or priority to each of the foregoing applications under 35 U.S.C. 119 or 120. The foregoing applications are incorporated by reference in their entirety as if fully set forth herein.

### FIELD OF THE INVENTION

This invention relates generally to a modular countertop system.

### SUMMARY

In one embodiment, a countertop system includes, but is not limited to, a first countertop section composed of a foam core at least partly covered by a laminate layer; a plurality of interconnection receptacles embedded within the foam core; and a plurality of cut-line indications on a bottom surface of the first countertop section at positions that correspond to the plurality of interconnection receptacles embedded within the foam core, wherein cutting of the first countertop section along any of the plurality of cut-line indications exposes at least one of the plurality of interconnection receptacles.

In another embodiment, a countertop system kit includes, but is not limited to, a first countertop section composed of a foam core at least partly covered by a laminate layer, the first countertop section including one or more first magnetic elements having first three-dimensional mechanical surface pattern disposed on at least one uncut end of the first countertop section; a plurality of interconnection receptacles embedded within the foam core; a plurality of cut-line indications on a bottom surface of the first countertop section at positions that correspond to the plurality of interconnection receptacles embedded within the foam core, wherein cutting of the first countertop section along any of the plurality of cut-line indications exposes at least one of the plurality of interconnection receptacles; at least one second magnetic element having the first three-dimensional mechanical surface pattern that is insertable within at least one of the plurality of interconnection receptacles following cutting of the first countertop section; and at least one endcap or sidesplash including one or more third magnetic elements having a second three-dimensional mechanical surface pattern for interlocking with the first three-dimensional mechanical surface pattern of the first and second magnetic elements.

In a further embodiment, a countertop system kit includes, but is not limited to, a first countertop section composed of a foam core at least partly covered by a laminate layer; a plurality of embedded interconnection receptacles within the foam core; at least one bottom interconnection receptacle on a bottom surface of the foam core; a plurality of 45 and 90 degree cut-line indications on the bottom surface of the first countertop section at positions that correspond to the plurality of embedded interconnection receptacles embedded within the foam core, wherein cutting of the first countertop section along any of the plurality of 45 and 90 degree cut-line indications exposes at least one of the plurality of embedded interconnection receptacles; at least one first magnetic element having a first three-dimensional mechanical surface pattern that is insertable within at least one of the plurality of embedded interconnection receptacles; at least one peg that is insertable within the foam core at a side edge; at least one endcap or sidesplash having at least one edge interconnection receptacle and at least one aperture for receiving the at least one peg; one or more second magnetic elements having a second three-dimensional mechanical surface pattern for interlocking with the first three-dimensional mechanical surface pattern of the at least one first magnetic element, the one or more second magnetic elements being insertable within the at least one edge interconnection receptacle or the at least one bottom interconnection receptacle; and at least one bracket mountable to at least one cabinet and including at least one third magnetic element having the first three-dimensional mechanical surface pattern that is configured for interlocking the second three-dimensional mechanical surface pattern of the one or more second magnetic elements inserted within the at least one bottom interconnection receptacle to secure the first countertop section to the at least one cabinet.

### BRIEF DESCRIPTION OF THE DRAWINGS

Embodiments of the present invention are described in detail below with reference to the following drawings:

FIG. 1 is a top perspective view of a modular countertop system, in accordance with an embodiment of the invention;

FIG. 2 is a bottom perspective view of a modular countertop system, in accordance with an embodiment of the invention;

FIG. 3 is a top perspective view of various cuts for a countertop, in accordance with an embodiment of the invention;

FIG. 4 is a top perspective view of a joint of a countertop, in accordance with various embodiments of the invention;

FIG. 5 is a top perspective view of a modular countertop system, in accordance with an embodiment of the invention; and

FIG. 6 is a bottom perspective view of a cabinet attachment system of a modular countertop system, in accordance with an embodiment of the invention.

### DETAILED DESCRIPTION

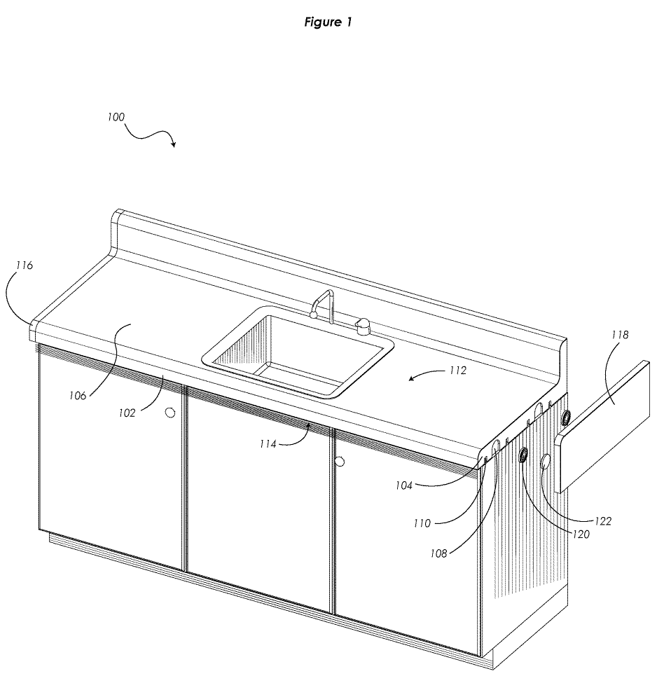

This invention relates generally to a modular countertop system. Specific details of certain embodiments of the invention are set forth in the following description, FIGS. 1-6, and Appendix A to provide a thorough understanding of such embodiments. The present invention may have additional embodiments, may be practiced without one or more of the details described for any particular described embodiment, or may have any detail described for one particular embodiment practiced with any other detail described for another embodiment.

FIG. 1 is a top perspective view of a modular countertop system, in accordance with an embodiment of the invention. In one embodiment, a countertop system 100 includes, but is not limited to, a first countertop section 102 composed of a foam core 104 at least partly covered by a laminate layer 106; a plurality of interconnection receptacles 108 embedded within the foam core 104; and a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108. In one embodiment, the countertop system 100 further includes at least one endcap 116 or sidesplash 118 with one or more magnetic elements 122. The first countertop section 102 includes one or more receptacles 108 on at least one end to receive one or more magnetic elements 120 to magnetically interconnect with a second countertop section, endcap 116, or sidesplash 118.

In another embodiment, a countertop system kit 100 includes, but is not limited to, a first countertop section 102 composed of a foam core 104 at least partly covered by a laminate layer 106; a plurality of interconnection receptacles 108 embedded within the foam core 104; a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108; at least one first magnetic element 120 having a first three-dimensional mechanical surface pattern that is insertable within at least one of the plurality of interconnection receptacles 108; and at least one endcap 116 or sidesplash 118 including one or more second magnetic elements 122 having a second three-dimensional mechanical surface pattern for interlocking with the first three-dimensional mechanical surface pattern of the at least one first magnetic element 120.

In some embodiments the countertop section 102 can include a plurality of sections. The countertop section 102 can be of varying sizes, shapes, dimensions, and be constructed from various materials. For instance, the countertop section 102 can be constructed of particle board, wood, plastic, fiberglass, tile, stone, fabric, metal, or other synthetic or natural material or combination of materials. The countertop section 102 can be longer, shorter, wider, narrower, thicker, or thinner. For example, the countertop section 102 can be approximately 0.5 inches to 3 inches thick, 3 feet to 12 feet long, and 1 foot to 5 feet deep. However, these are exemplary only and any size or dimension is possible. The countertop section 102 can be oval, square, rectangular, circular, or any other regular or irregular shape. The edges of the countertop section 102 can be sharp or rounded. The countertop section 102 can include a backsplash or be included without a backsplash. The countertop section 102 can include inserts such as a cutting board, stove, 110/220 volt outlet, or USB charging station.

As discussed herein, the foam core 104 and the laminate layer 106 can be substituted with other materials. In the embodiments with foam and laminate, the foam core 104 provides a lightweight solid structure for wrapping the ornamental and durable laminate layer 106. The foam core 104 can include fiber, paper, rubber, vinyl, balsa, plastic or other similar natural or synthetic product. The term foam is therefore intended to be broad and include any of the aforementioned materials and their equivalents. The laminate layer 106 can include paper bonded with resins, or other similar substitute, which can be in any color or pattern. The foam core 104 can be partially or entirely wrapped with the laminate layer 106 or the laminate layer 106 can be provided separately for field bonding to the foam core 104.

The interconnection receptacle 108 is sized and shaped to receive the magnetic element 120 therein such that the magnetic element is substantially flush with an edge surface of the countertop section 102. The interconnection receptacles 108, as discussed and further illustrated herein, are embedded within the foam core 104 at various positions throughout the countertop section 102 and are revealed by cutting the countertop section 102 to the desired size or shape. Note that the interconnection receptacles 108 can be on uncut ends as illustrated in FIG. 1 in addition to the embedded receptacles 108 within the foam core 104, permitting use of the interconnection receptacles 108 in the case where the countertop section 102 is sized properly without cutting. The interconnection receptacle 108 can have a width that is slightly undersized relative to the magnetic element 120 and/or include a lip, taper, or flange to secure the magnetic element 120 therein. For example, the interconnection receptacle 108 can be circular with a diameter slightly smaller than that of the magnetic element 120 and a depth that is substantially equivalent to that of the magnetic element 120. The magnetic element 120 can therefore be pushed within the interconnection receptacle 108 to secure the magnetic element 120 therein. In certain embodiments, glue or adhesive can be included or added to the receptacle 108 to bond with the magnetic element 120 to secure the magnetic element 120 therein.

The magnetic elements 120 and 122 are magnets with mating surfaces which provides a strong yet removable attachment point. One or more of the magnetic elements 120 can be inserted within the interconnection receptacles 108 and one or more of the magnetic elements 122 can be inserted within interconnection receptacles 108 of an adjoining countertop section, endcap 116, or sidesplash 118, to enable the countertop section 102 to be easily and securely capped or extended without requiring the use of fasteners or tools. The magnetic elements 120 and 122 can include an adhesive back that bonds to the interconnection receptacles 108 and/or the magnetic elements 120 can be sized and shaped for friction locking within the interconnection receptacles 108. For instance, the magnetic elements 120 and 122 can include a flange, taper, teeth, or the like about the perimeter or circumference edge.

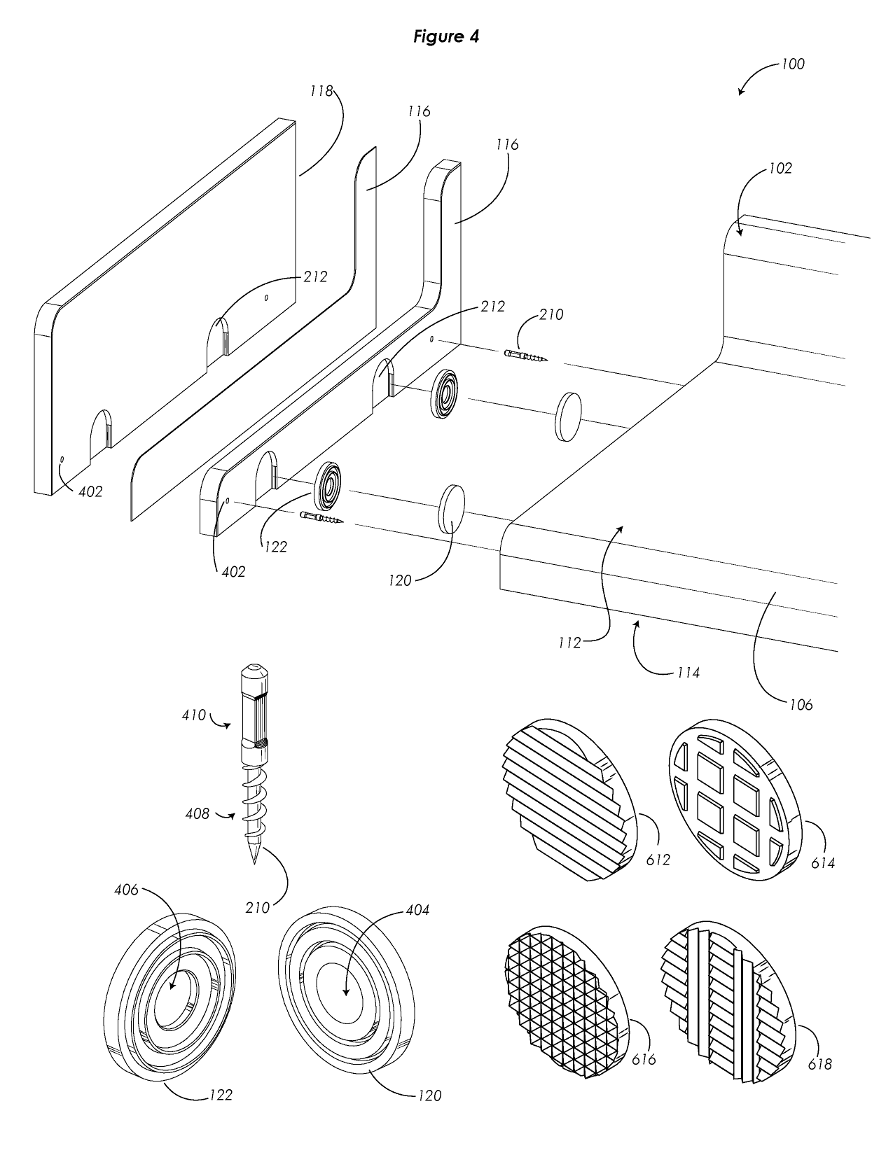

The sidesplash 118 and the endcap 116 are provided to finish an end of the countertop section 102 following cutting of the countertop section 102 to size. The sidesplash 118 can be added to one side of the countertop section 102 and the endcap 116 can be added to the other side of the countertop section 102. Alternatively, a sidesplash 118 can be added to both ends of the countertop section 102 or the endcap 116 can be added to both ends of the countertop section 102. The sidesplash 118 and the endcap 116 can be of similar material and thickness as compared to the countertop section 102 or can be of different material or thickness. For instance, the sidesplash 118 or endcap 116 can be metal, wood, plastic, or other similar material to provide a desired trim to the countertop section 102. Alternatively, the sidesplash 118 or the endcap 116 can be similarly formed from foam and laminate. The endcap 116 can also be a laminate strip that can be bonded to the countertop section 102. For example, the endcap 116 can be a thin piece of laminate or plastic that includes an adhesive side, which piece shares a cross-sectional shape as the countertop section 102. The adhesive side can be protected by a removable film, which once removed exposes the adhesive for application of the endcap 116 to an unfinished end of the countertop section 102. The endcap 116 can be shaped for either right or left side application and can alternatively be shaped to fit a 45 or 30 or other non-right-angle cut of the countertop section 102. Note that the endcap 116 can also have glue or other bonding material applied to one surface for application to the countertop section 102. Alternatively, as further discussed herein, the sidesplash 118 or the endcap 116 include receptacles 108 to accept the magnetic element 122 for magnetically coupling to the countertop section 102 without requiring the use of tools or fasteners. See FIG. 4 for additional detail on endcap 116 alternatives.

The countertop system 100 can be used in bathrooms, kitchens, laundry rooms, workshops, or in any other location where a countertop is desired. One specific environment where the countertop system 100 is useful is multi-family rental properties where installation, replacement, and repair of countertops commonly occurs during turnover. In whichever environment used, the countertop system 100 enables faster installation and removal with reduced or no requirement for fasteners and fewer tools. The countertop sections 102 are cut to size using the provided cut line indications and then joined together and trimmed as desired using the interconnection receptacles 108 and the magnetic elements 120 and 122. Removal can then be accomplished by forcibly separating the magnetic elements 120 and 122. Therefore, installing, repairing, removing, or making seasonal decorative changes to countertops can be accomplished efficiently.

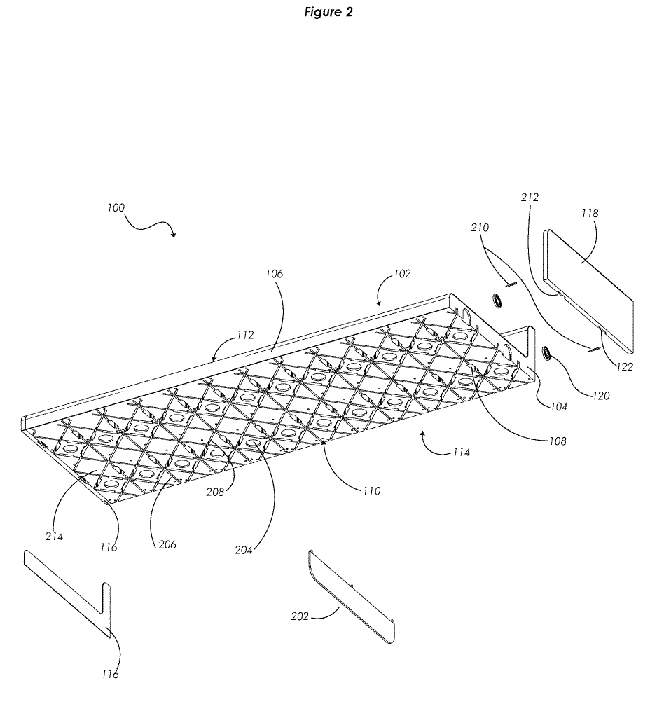

FIG. 2 is a bottom perspective view of a modular countertop system, in accordance with an embodiment of the invention. In one embodiment, a countertop system 100 includes, but is not limited to, a first countertop section 102 composed of a foam core 104 at least partly covered by a laminate layer 106; a plurality of interconnection receptacles 108 embedded within the foam core 104; and a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108.

In another embodiment, a countertop system kit 100 includes, but is not limited to, a first countertop section 102 composed of a foam core 104 at least partly covered by a laminate layer 106; a plurality of interconnection receptacles 108 embedded within the foam core 104; a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108; at least one first magnetic element 120 having a first three-dimensional mechanical surface pattern that is insertable within at least one of the plurality of interconnection receptacles 108; and at least one endcap 116 or sidesplash 118 including one or more second magnetic elements 122 having a second three-dimensional mechanical surface pattern for interlocking with the first three-dimensional mechanical surface pattern of the at least one first magnetic element 120.

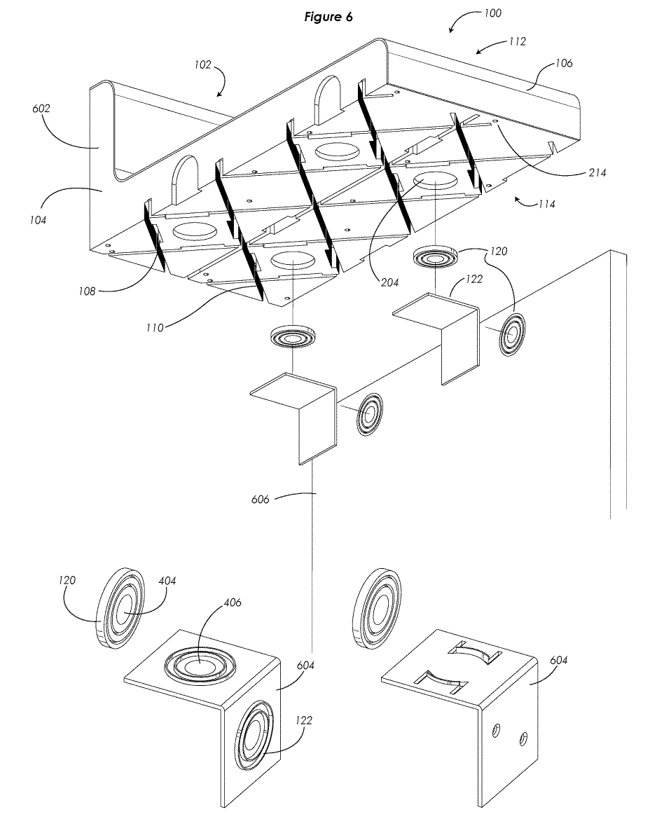

In a further embodiment, a countertop system kit 100 includes, but is not limited to, a first countertop section 102 composed of a foam core 104 at least partly covered by a laminate layer 106; a plurality of embedded interconnection receptacles 108 within the foam core 104; at least one bottom interconnection receptacle 204 on a bottom surface 114 of the foam core 104; a plurality of 45 and 90 degree cut-line indications on the bottom surface of the first countertop section at positions that correspond to the plurality of embedded interconnection receptacles embedded within the foam core, wherein cutting of the first countertop section along any of the plurality of forty-five degree cut line indications 208 and ninety degree cut-line indications 206 exposes at least one of the plurality of embedded interconnection receptacles 108; at least one first magnetic element 120 having a first three-dimensional mechanical surface pattern that is insertable within at least one of the plurality of embedded interconnection receptacles 108; at least one peg 210 that is insertable within the foam core at a side edge; at least one endcap 116 or sidesplash 118 having at least one edge interconnection receptacle 210 and at least one aperture for receiving the at least one peg 212; one or more second magnetic elements 122 having a second three-dimensional mechanical surface pattern for interlocking with the first three-dimensional mechanical surface pattern of the at least one first magnetic element 120, the one or more second magnetic elements 122 being insertable within the at least one edge interconnection receptacle 212 or the at least one bottom interconnection receptacle 204; and at least one bracket mountable to at least one cabinet and including at least one third magnetic element having the first three-dimensional mechanical surface pattern that is configured for interlocking the second three-dimensional mechanical surface pattern of the one or more second magnetic elements 122 inserted within the at least one bottom interconnection 204 receptacle to secure the first countertop section 102 to the at least one cabinet (FIG. 6).

In one embodiment, the countertop section 102 includes a plurality of cut-line indications 110 on the bottom surface 114 including ninety degree cut line indications 206, forty-five degree cut line indications 208, or 30 degree cut-lines (not shown). The cutline indications 110 provide assistance in cutting the countertop section 102 to length and shape for installation. The cutline indications 110 additionally are each associated with one or more of the embedded interconnection receptacles 108 such that cutting the countertop section along any of the cutline indications 110 (including the 90 degree indications 206 or the 45 degree indications 208) exposes one or more of the embedded interconnection receptacles 108. Thus, the countertop section 102 can be cut at 90 degree or 45 degree cuts at any of the cut line indications 110 to reveal one or more of the embedded interconnection receptacles 108. The magnetic elements 120 can be placed within the exposed interconnection receptacles 108 for magnetically joining an adjacent countertop section 102, endcap 116, or sidesplash 118.

In certain embodiments, the plurality of cut-line indications 110 are surface indicia. That is, the cut line indications 110 such as the ninety degree cut line indications 206 and the forty-five degree cut line indications 208 can be a sticker, paint, ink, perforation, or other similar surface marking that provides a visual indication of the location of the cut line indications 110. Alternatively, as depicted, the plurality of cut-line indications 110 such as the ninety degree cut line indications 206 and the forty-five degree cut line indications 208 can include mechanical surface grooves that at least partially guide a saw. The surface grooves can be shallow or deep and wide or narrow. The surface grooves may include a lip, flange, or edge type protrusion. In one particular embodiment, the cut line indications 110 include surface grooves that are approximately 1 mm-5 mm wide and approximately 1 mm-10 mm deep and are sized to receive and provide some guidance for a saw blade. In other embodiments, the cut line indications 110 are omitted in full or in part (e.g., the 45 degree cut line indications 208 can be optionally omitted near ends of the countertop section 102).

In some embodiments, the first countertop section 102 includes one or more mounting apertures 214 on the bottom surface 114 at positions that correspond to the plurality of cut-line indications 110, which one or more mounting apertures 214 are configured to secure a saw guide or rip fence 202 therein. The apertures 214 are positioned in groups (e.g., pairs) along each of the cut line indications 110 such as the ninety degree cut line indications 206 and the forty-five degree cut line indications 208. The saw guide or rip fence 202 includes pegs that are removably insertable within the apertures 214 to correspond with any of the cut line indications 110 such as the ninety degree cut line indications 206 and the forty-five degree cut line indications 208. A circular saw or other similar cutting tool can thereafter rely upon the saw guide or rip fence 202 to provide a clean and straight cut along any of the cut line indications 110 such as the ninety degree cut line indications 206 and the forty-five degree cut line indications 208.

In certain embodiments, the embedded interconnection receptacles 108 are positioned at various locations corresponding to the cut line indications 110 and also on at least one uncut end to receive one or more magnetic elements to magnetically interconnect with a second countertop section 102, endcap 116, or sidesplash 118. The interconnection receptacles 108 can be variously sized and shaped, such as circular, semi-circular, rectangular, square, or other regular or irregular shape. The receptacles 108 can be thin or thick. The receptacles 108 can be separate individual receptacles or can include one or more center-bores along a length or width of the countertop section 102. In one particular example, the receptacles 108 are illustrated as each being a half-oval shape with a depth into the countertop section of approximately 1 cm to 5 cm and an opening of approximately 1 mm to 1 cm by approximately 1 cm to 5 cm. This particular shape permits the receptacles 108 to be efficiently established during the manufacturing process while maintaining structural integrity of the countertop section 102. The receptacles 108 can be positioned at locations along the cut lines 110 such that the receptacles 108 will coincide with adjacent receptacles 108 of another cut countertop section 102. For the 90 degree cut line indications 206, the receptacles 108 are positioned at two or more of the same locations on each 90 degree cut line indication 206. For the 45 degree cut line indications 208, the receptacles 108 are positioned at two or more of the same locations on each of the 45 degree cut line indications 208, with each half of the receptacle 108 being offset from the other half. The offset permits the receptacles 108 of two 45 degree cut countertop sections 102 to coincide with one another. In certain embodiments, there are one, two, three, or more interconnection receptacles for each cut line indication 110 or each end of an uncut countertop section.

In certain embodiments, the cut line indications 110 can include 30, 45, or 90 degree lines relative to an edge of the countertop section 110. Additional cut line indications 110 can be provide from 1-89 degrees. Additionally, the cut line indications 110 can be linear, curvilinear, or any other regular or irregular line or shape. The cut line indications 110 can be closer together or farther apart and can be evenly or non-evenly distributed. In one particular embodiment, the cut line indications 110 are evenly distributed at approximately 2 cm to 15 cm apart.

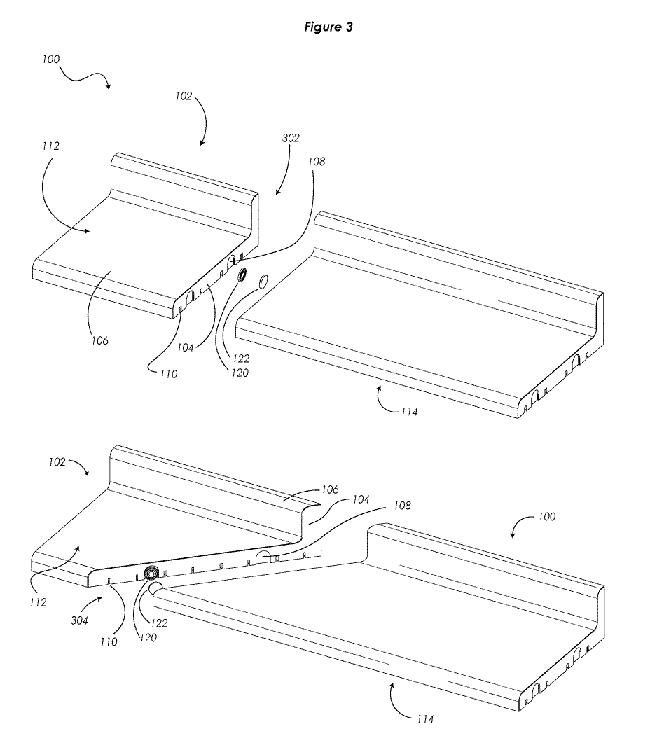

FIG. 3 is a top perspective view of various cuts for a countertop, in accordance with an embodiment of the invention. In one embodiment, a countertop system 100 includes, but is not limited to, a first countertop section 102 composed of a foam core 104 at least partly covered by a laminate layer 106; a plurality of interconnection receptacles 108 embedded within the foam core 104; and a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108.

Further depicted are a ninety degree cut 302 of the first countertop section 102 and a forty-five degree cut 304 of the first countertop section 102. The 90 degree cut 302 can be used to shorten the first countertop section 102 to a desired length for installation. Alternatively, the 90 degree cut 302 can be used to join the first countertop section 102 with another 90 degree cut of 302 of another countertop section 102. The forty-five degree cut 304 can be used to angle the first countertop section 102 at a desired length for joining with another countertop section 102 also having a 45 degree cut 304, thereby forming a 90 degree turn by joining two countertop sections 102. The 90 degree cut 302 and the 45 degree cut 304 can be made at any of the cut line indications 110 as further depicted in FIG. 3. Further, the 90 degree cut 302 and the 45 degree cut can be combined in one or more of the countertop sections 102. Therefore, one or more countertop sections 102 can be cut and joined to form a large number of possible countertop surface shapes, such as L-shapes, U-shapes, Z-shapes, or other similar shape. Moreover, it is possible to add 30 degree cut line indications or other cut line indications as discussed herein and it is possible to make cuts to the countertop sections that do not coincide with any cut line indications 110. This flexibility enables even more possibilities for countertop surface shapes.

In one embodiment, at least one magnetic element 120 or 122 is insertable into at least one of the plurality of interconnection receptacles 108 following cutting of the first countertop section 102 to magnetically couple with a second countertop section 102. The at least one magnetic element 120 or 122 can have one or more mechanical three-dimensional surface patterns. The magnetic elements 120 or 122 can be various sizes or shapes, such as square, triangular, oval, circular, rectangular, or other regular or irregular shape. Either of the magnetic elements 120 or 122 can be magnets or can be metal or both of the magnetic elements 120 or 122 can be magnets. The mechanical three-dimensional surface pattern can include any surface protrusion or recess that mates with a complementary mechanical three-dimensional surface pattern, including sawtooth, meat tenderizer, opposing teeth, concentric ring, peg, hole, or other similar pattern. In one particular embodiment, the magnetic elements 120 or 122 are circular magnetics having interfitting concentric ring surface patterns. The magnetic elements 120 or 122 are placed within the embedded interconnection receptacles 108 and secured therein through friction or bonding, therefore enabling two countertop sections 102 to be magnetically joined together.

In some embodiments, the plurality of interconnection receptacles 108 include at least one groove operable to interconnect with at least one tongue of a second countertop section 102. That is, two countertop sections can be joined using a tongue and groove interlocking mechanism in lieu of the magnetic elements 120 or 122 or in addition to the magnetic elements 120 or 122. The groove can be embedded in the foam core 104 such that the groove is exposed when the countertop section 102 is cut along a cut line indication 110. The tongue can be located on an uncut end of a countertop section 102 for insertion within the groove of a cut countertop section 102. The countertop section 102 can be manufactured with a 45 degree end or a 90 degree end or some other angular or curvilinear end including the tongue.

In another embodiment, the plurality of interconnection receptacles 108 include at least one female receptacle operable to interconnect with at least one male protrusion of a second countertop section 102. That is, two countertop sections can be joined using male and female interlocking mechanisms in lieu of the magnetic elements 120 or 122 or in addition to the magnetic elements 120 or 122. The female receptacle can be embedded in the foam core 104 such that the female receptacle is exposed when the countertop section 102 is cut along a cut line indication 110. The male protrusion can be located on an uncut end of a countertop section 102 for insertion within the female receptacle of a cut countertop section 102. The countertop section 102 can be manufactured with a 45 degree end or a 90 degree end or some other angular or curvilinear end including the male protrusion.

In a further embodiment, the plurality of interconnection receptacles 108 include at least one tapered receptacle operable to interconnect with at least one wedged protrusion of a second countertop section 102. That is, two countertop sections can be joined using a tapered receptacle and a wedged protrusion in lieu of the magnetic elements 120 or 122 or in addition to the magnetic elements 120 or 122. The tapered receptacle can be embedded in the foam core 104 such that the tapered receptacle is exposed when the countertop section 102 is cut along a cut line indication 110. The wedged protrusion can be located on an uncut end of a countertop section 102 for insertion within the tapered receptacle of a cut countertop section 102. The countertop section 102 can be manufactured with a 45 degree end or a 90 degree end or some other angular or curvilinear end including the wedged protrusion.

In yet another possible embodiment, the plurality of interconnection receptacles 108 include at least one receptacle operable to interconnect with at least one hook of a second countertop section 102. That is, two countertop sections can be joined using a receptacle and a hook in lieu of the magnetic elements 120 or 122 or in addition to the magnetic elements 120 or 122. The receptacle can be embedded in the foam core 104 such that the receptacle is exposed when the countertop section 102 is cut along a cut line indication 110. The receptacle can include a cross-member, flange, extension, lip, recess, pocket, cavity, or the like. The hook can be located on an uncut end of a countertop section 102 for insertion within the receptacle of a cut countertop section 102 such that the hook is securable to the cross-member, flange, extension, lip, recess, pocket, cavity, or the like of the receptacle. The countertop section 102 can be manufactured with a 45 degree end or a 90 degree end or some other angular or curvilinear end including the hook.

In one particular embodiment, at least one peg is provided for insertion into the foam core to join two countertop sections together. The peg can be used instead of or in addition to the magnetic elements to secure the countertop sections 102 together. The peg can include a screw on one or both ends and a rod or protrusion on one or more ends. In one particular embodiment, the peg includes a screw on one end and a rod on the opposing end, which rod includes an interface to receive a screw driver or a wrench (e.g., phillips, flathead, socket wrench, or hand wrench) for screwing the peg into a cut end of a countertop section 102. In this embodiment, an uncut countertop section includes an aperture for insertion of the rod end of the peg thereby removably interlocking the countertop sections 102 together. In yet another particular embodiment, a cam is provided in the end of the countertop section 102 to further grip the rod end of the peg.

In an alternative embodiment, at least one buckle is provided that is installable into the foam core 104 of the first countertop section 102 to interlock with at least one latch of a second countertop section 102. The bottom surface 114 of the countertop sections 102 can include mounting locations such as holes, nut plates, threaded collars, mounted nuts, or the like for securing a buckle and latch using fasteners such as screws, bolts, nails, pins, rivets, or the like. Therefore, a buckle can be installed on one countertop section 102 and a latch can be installed on another countertop section 102 and the countertop sections 102 can be joined and secured together via interlocking of the buckle and the latch. The buckle and the latch can be used in lieu or in addition to the magnetic elements. In one particular embodiment, a plurality of pockets are provided on the bottom surface of the countertop section 102 at positions that correspond to the plurality of cut-line indications 110, wherein at least some of the pockets are usable to mount one or more buckles or latches to interlock with one or more buckles or latches of a second countertop section 102. The pockets are recesses disposed adjacent to the cut line indications 110. In one particular embodiment there are four pockets for each cut line indication 110, with two on either side of the cut line indication 110.

In some embodiments, the countertop section 102 can include as an embedded feature, as a feature on an uncut end, and/or as an installable feature any of the following: protrusion, receptacle, tongue, groove, tapered protrusion, wedged receptacle, hook, peg, cam, buckle, or magnetic element 120 or 122. These components are utilizable individually or in combination, to join two or more countertop sections 102 together, such as an uncut countertop section 102 to an uncut countertop section 102, a cut countertop section 102 to an uncut countertop section 102, or as a cut countertop section 102 to a cut countertop section 102. The countertop sections 102 can come in various sizes and shapes as discussed herein.

FIG. 4 is a top perspective view of a joint of a countertop, in accordance with various embodiments of the invention. In one embodiment, a countertop system kit 100 includes, but is not limited to, a first countertop section 102 composed of a foam core at least partly covered by a laminate layer 106; a plurality of interconnection receptacles embedded within the foam core; a plurality of cut-line indications on a bottom surface 114 of the first countertop section 102 at positions that correspond to the plurality of interconnection receptacles embedded within the foam core, wherein cutting of the first countertop section 102 along any of the plurality of cut-line indications exposes at least one of the plurality of interconnection receptacles; at least one first magnetic element 120 having a first three-dimensional mechanical surface pattern 404 that is insertable within at least one of the plurality of interconnection receptacles; and at least one endcap 116 or sidesplash 118 including one or more second magnetic elements 122 having a second three-dimensional mechanical surface pattern 406 for interlocking with the first three-dimensional mechanical surface pattern 404 of the at least one first magnetic element 120.

In one embodiment, at least one magnetic element 120 is insertable into at least one of the plurality of interconnection receptacles on an uncut end or following cutting of the first countertop section 102 to magnetically couple with a second countertop section 102, endcap 116, or sidesplash 118. The magnetic element 120 can be secured within an interconnection receptacle via friction. For instance, the interconnection receptacle can be slightly undersized or include a lip, taper, or flange. Alternatively, the magnetic element 120 can be slightly oversized or be tapered or include a lip or flange. The magnetic element 120 can optionally be secured within an interconnection receptacle via a twist or screw action. For instance, the magnetic element 120 can include a threaded circumference or a flange that can be twisted into mating threads or a recess of the interconnection receptacle. The magnetic element 120 can alternatively be bonded within the interconnection receptacle, such as using glue, adhesive, tape, or resin. Fasteners, such as screws or pins, are also optionally usable to secure the magnetic element 120 within the interconnection receptacle. In certain embodiments, the magnetic element 120 is integrated within the countertop section 102, such as on one or more uncut ends of the countertop section.

In some embodiments, at least one magnetic element 120 includes one or more mechanical three-dimensional surface patterns 404, which at least one magnetic element 120 is insertable into at least one of the plurality of interconnection receptacles an un uncut end or following cutting of the first countertop section 102 to magnetically couple with a second countertop section 102, endcap 116, or sidesplash 118. The mechanical surface pattern 404 can include any protrusion or recess. For instance, saw tooth, opposing teeth, or meat tenderizer are possible mechanical surface patterns 404, such as depicted in 612, 614, 616, or 618. Alternatively, the mechanical surface pattern 404 can include ridges, valleys, prongs, hooks, flanges, apertures, or other similar features. In one particular embodiment, the three-dimensional mechanical surface pattern 404 includes set of recessed concentric rings as depicted for interlocking with ridged concentric rings of a complementary magnetic element 122. The concentric rings of the surface pattern 404 can be one, two, three, four, or more rings and the rings can be evenly or non-evenly spaced. Additionally, the concentric rings can be circular, oval, square, or some other regular or irregular shape. The concentric rings can vary in size, width, and depth, but can include the following approximate measurements in certain embodiments: approximately 5 mm to 2.5 cm in diameter; approximately 1 mm to 5 mm in width; and approximately 1 mm to 5 mm in depth.

In one embodiment, at least one endcap 116 or sidesplash 118 includes one or more receptacles 212 and one or more magnetic elements 122 for interconnecting with and finishing the first countertop section 102. In one embodiment, at least one magnetic element 122 is insertable into at least one of the edge interconnection receptacles 212 to magnetically couple with a countertop section 102. The magnetic element 122 can be secured within an interconnection receptacle 212 via friction. For instance, the interconnection receptacle 212 can be slightly undersized or include a lip, taper, or flange. Alternatively, the magnetic element 122 can be slightly oversized or be tapered or include a lip or flange. The magnetic element 122 can optionally be secured within an interconnection receptacle 212 via a twist or screw action. For instance, the magnetic element 122 can include a threaded circumference or a flange that can be twisted into mating threads or a recess of the interconnection receptacle 212. The magnetic element 122 can alternatively be bonded within the interconnection receptacle 212, such as using glue, adhesive, tape, or resin. Fasteners, such as screws or pins, are also optionally usable to secure the magnetic element 122 within the interconnection receptacle 212. In certain embodiments, the magnetic element 122 is integrated within the endcap 116 or the sidesplash 118.

In some embodiments, at least one magnetic element 122 includes one or more mechanical three-dimensional surface patterns 406, which at least one magnetic element 122 is insertable into at least one of the plurality of edge receptacles 212 to magnetically couple with a countertop section 102. The mechanical surface pattern 406 can include any protrusion or recess. For instance, saw tooth, opposing teeth, or meat tenderizer are possible mechanical surface patterns 406, such as those depicted in 612, 614, 616, or 618. Alternatively, the mechanical surface pattern 406 can include ridges, valleys, prongs, apertures, hooks, flanges, or other similar features. In one particular embodiment, the three-dimensional mechanical surface pattern 406 includes set of ridged concentric rings as depicted for interlocking with recessed concentric rings of a complementary magnetic element 120. The concentric rings of the surface pattern 406 can be one, two, three, four, or more rings and the rings can be evenly or non-evenly spaced. Additionally, the concentric rings can be circular, oval, square, or some other regular or irregular shape. The concentric rings can vary in size, width, and depth, but can include the following approximate measurements in certain embodiments: approximately 5 mm to 2.5 cm in diameter; approximately 1 mm to 5 mm in width; and approximately 1 mm to 5 mm in height. The magnetic elements 120 and 122 can be reversed such that the magnetic element 120 is inserted in the endcap 116 or sidesplash 118 and the magnetic element 122 is inserted in the countertop section 102.

In one particular embodiment, at least one endcap 116 or sidesplash 118 includes one or more protrusions for interconnecting with the first countertop section 102. The protrusion can be a post, extension, flange, member, ridge, or the like and can be inserted within or integrated with the endcap 116 or the sidesplash 118. Note that the protrusions can be in addition to or in lieu of the magnetic or other couplings. When used in addition to the magnetic elements 120 or 122, the protrusion can further secure the endcap 116 or sidesplash 118 to the countertop section 102. In one instance, the protrusion is a peg 210 that includes a threaded screw end 408 and a post end 410. The threaded end 408 is twisted into an end of the countertop section 102 and the post end 410 is inserted into a peg aperture 402 of an endcap 116 or sidesplash 118. The post end 410 can include an interface for a wrench or screwdriver to facilitate twisting of the peg 210. In certain other embodiments, the peg 210 can include on one or both ends a barb, thread, post, hook, or other mechanical feature to assist in securing the peg 210 to the countertop section 102 or to the endcap 116 or sidesplash 118. The peg can be shorter or longer to accommodate various widths of endcaps 116 or sidesplashes 118 and can range from approximately 1 cm to 5 cm in length. There can be one, two, three, four or more pegs 210 for each endcap 116 or sidesplash 118 or the pegs 210 can be omitted. The peg apertures 402 can be prepunched or predrilled or can be omitted. In another embodiment, the apertures 402 include a cam that twists to lock the peg 210 therein.

In other embodiments, the countertop section 102 includes one or more protrusions on at least one uncut or cut end to interconnect with an endcap 116 or sidesplash 118. The protrusion can be a post, extension, flange, member, ridge, or the like and can be inserted within or integrated with the countertop section 102. Note that the protrusions can be in addition to or in lieu of the magnetic or other couplings. When used in addition to the magnetic elements 120 or 122, the protrusion can further secure the endcap 116 or sidesplash 118 to the countertop section 102. In one instance, the protrusion is a peg 210 that includes a threaded screw end 408 and a post end 410. The threaded end 408 is twisted into an end of the endcap 116 or sidesplash 118 and the post end 410 is inserted into a peg aperture 402 of the countertop section 102. The post end 410 can include an interface for a wrench or screwdriver to facilitate twisting of the peg 210. In certain other embodiments, the peg 210 can include on one or both ends a barb, thread, post, hook, or other mechanical feature to assist in securing the peg 210 to the countertop section 102 or to the endcap 116 or sidesplash 118. The peg can be shorter or longer to accommodate various widths of endcaps 116 or sidesplashes 118 and can range from approximately 1 cm to 5 cm in length. There can be one, two, three, four or more pegs 210 for each endcap 116 or sidesplash 118 or the pegs 210 can be omitted. The peg apertures 402 can be present in the countertop section 102 and can be prepunched or predrilled or can be omitted. In another embodiment, the apertures 402 in the countertop section 102 include a cam that twists to lock the peg 210 therein.

In certain embodiments, the countertop section 102, the endcap 116, or the sidesplash 118 include alternative or additional features to enable joining therebetween. For instance, the countertop section 102, the endcap 116, or the sidesplash 118 can include one or more tongues to interconnect with at least one groove of a mating countertop section 102, endcap 116, or sidesplash 118. Alternatively, the countertop section 102, the endcap 116, or the sidesplash 118 can include at least one female receptacle on at least one end to interconnect with at least one male protrusion of a mating countertop section 102, endcap 116, or sidesplash 118. Additionally, the countertop section 102, the endcap 116, or the sidesplash 118 can include one or more tapered protrusions on at least one end to interconnect with at least one wedged receptacle element of a joining countertop section 102, endcap 116, or sidesplash 118. Likewise, the countertop section 102, the endcap 116, or the sidesplash 118 can include one or more hooks on at least one end to interconnect with at least one receptacle element of an interconnecting countertop section 102, endcap 116, or sidesplash 118. In addition to the aforementioned features, in some embodiments the countertop section 102, the endcap 116, or the sidesplash 118 can include one or more buckles for interconnecting with one or more latches of an adjoining countertop section 102, endcap 116, or the sidesplash 118. Optionally, the sidesplash 118 and/or the endcap 116 can be attached to the countertop section using adhesive, glue, epoxy, or other similar bonding agent. Any of these features and/or mechanisms can be used in conjunction with or in alternative to the magnetic elements 120 or 122.

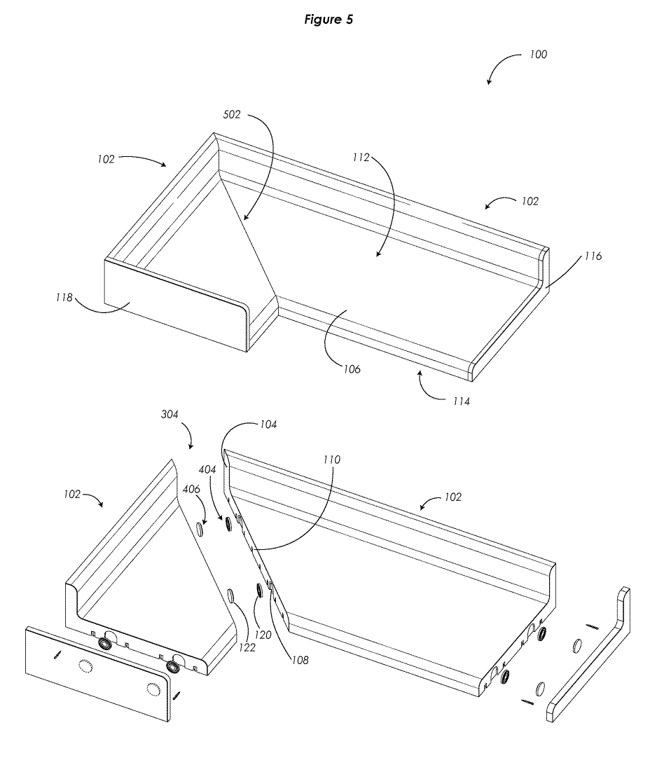

FIG. 5 is a top perspective view of a modular countertop system, in accordance with an embodiment of the invention. In one embodiment, the countertop system includes, but is not limited to, a first countertop section 102 composed of a foam core 104 at least partly covered by a laminate layer 106; a plurality of interconnection receptacles 108 embedded within the foam core 104; and a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108.

In another embodiment, a countertop system kit 100 includes, but is not limited to, a first countertop section 102 composed of a foam core 104 at least partly covered by a laminate layer 106; a plurality of interconnection receptacles 108 embedded within the foam core 104; a plurality of cut-line indications 110 on a bottom surface 114 of the first countertop section 102 at positions that correspond to the plurality of interconnection receptacles 108 embedded within the foam core 104, wherein cutting of the first countertop section 102 along any of the plurality of cut-line indications 110 exposes at least one of the plurality of interconnection receptacles 108; at least one first magnetic element 120 having a first three-dimensional mechanical surface pattern 404 that is insertable within at least one of the plurality of interconnection receptacles 108; and at least one endcap 116 or sidesplash 118 including one or more second magnetic elements 122 having a second three-dimensional mechanical surface pattern 406 for interlocking with the first three-dimensional mechanical surface pattern 404 of the at least one first magnetic element 120.

In one embodiment, at least one magnetic element 120 or 122 is insertable into at least one of the plurality of interconnection receptacles 108 at an uncut end or following cutting of the first countertop section 102 to magnetically couple with a second countertop section 102 along seam 502 in similar fashion as described and illustrated with respect to the endcap 116 or sidesplash 118. Indeed, the magnetic elements 120 or 122 can be interchangeably used to connect countertop sections 102, sidesplashes 118, or endcaps 116. However, it is possible to use different magnetic elements or coupling mechanisms for one of more of joining countertop sections 102, sidesplashes 118, or endcaps 116.

In one embodiment, the magnetic element 120 or 122 can be secured within an interconnection receptacle 108 via friction. For instance, the interconnection receptacle 108 can be slightly undersized or include a lip, taper, or flange. Alternatively, the magnetic element 120 or 122 can be slightly oversized or be tapered or include a lip or flange. The magnetic element 120 or 122 can optionally be secured within an interconnection receptacle 108 via a twist or screw action. For instance, the magnetic element 120 or 122 can include a threaded circumference or a flange that can be twisted into mating threads or a recess of the interconnection receptacle 108. The magnetic element 120 or 122 can alternatively be bonded within the interconnection receptacle 108, such as using glue, adhesive, tape, or resin. Fasteners, such as screws or pins, are also optionally usable to secure the magnetic element 120 or 122 within the interconnection receptacle 108. In certain embodiments, the magnetic element 120 or 122 is integrated within the countertop section 102, such as on one or more uncut ends of the countertop section. Note that the magnetic elements 120 or 122 can be interchangeably be inserted within interconnection receptacles 108 of either end of the countertop section 102.

In some embodiments, at least one magnetic element 120 or 122 includes one or more mechanical three-dimensional surface patterns 404 or 406, which at least one magnetic element 120 or 122 is insertable into at least one of the plurality of interconnection receptacles 108 an un uncut end or following cutting of the first countertop section 102 to magnetically couple with a second countertop section 102 along a seam 502 similar in fashion to that described with respect to endcap 116 and sidesplash 118. The mechanical surface pattern 404 or 406 can include any protrusion or recess. For instance, saw tooth, opposing teeth, or meat tenderizer are possible mechanical surface patterns 404 or 406. Alternatively, the mechanical surface pattern 404 or 406 can include ridges, valleys, prongs, hooks, flanges, apertures, or other similar features. In one particular embodiment, the three-dimensional mechanical surface pattern 404 or 406 includes set of recessed concentric rings as illustrated herein for interlocking with ridged concentric rings of a complementary magnetic element 120 or 122. The concentric rings of the surface pattern 404 or 406 can be one, two, three, four, or more rings and the rings can be evenly or non-evenly spaced. Additionally, the concentric rings can be circular, oval, square, or some other regular or irregular shape. The concentric rings can vary in size, width, and depth, but can include the following approximate measurements in certain embodiments: approximately 5 mm to 2.5 cm in diameter; approximately 1 mm to 5 mm in width; and approximately 1 mm to 5 mm in depth or height.

In one particular embodiment, a peg similar to peg 210 is provided that is insertable into adjoining ends of two countertop sections 102 to further secure the countertop sections 102 along the seam 502. The peg can include on one or more ends threads, a post, a barb, a hook, or other mechanical feature. For example, the peg can include a threaded screw end and a post end with a barb. The threaded end is twisted into an end of the countertop section 102 and the post end with the barb is inserted into another end of an adjoining countertop section 102. The post end can include an interface for a wrench or screwdriver to facilitate twisting of the peg. The peg can be shorter or longer to accommodate various insertion depths and can range from approximately 1 cm to 5 cm in length. There can be one, two, three, four or more pegs for each seam 502 or the pegs can be omitted. Peg apertures can be prepunched or predrilled or can be omitted as embedded features or in ends of the countertop section 102. In another embodiment, the peg apertures can include a cam that twists to lock the peg therein.

In certain embodiments, the countertop sections 102 can include alternative or additional features on an uncut end or embedded within (e.g., exposed via one or more cuts along a cut line indication 110) to enable joining therebetween. For instance, the countertop section 102 can include one or more tongues to interconnect with at least one groove of a mating countertop section 102. Alternatively, the countertop section 102 can include at least one female receptacle on at least one end to interconnect with at least one male protrusion of a mating countertop section 102. Additionally, the countertop section 102 can include one or more tapered protrusions on at least one end to interconnect with at least one wedged receptacle element of a joining countertop section 102. Likewise, the countertop section 102 can include one or more hooks on at least one end to interconnect with at least one receptacle element of an interconnecting countertop section 102. In addition to the aforementioned features, in some embodiments the countertop section 102 can include one or more buckles for interconnecting with one or more latches of an adjoining countertop section 102. Optionally, adjoining countertop sections 102 can be attached using adhesive, glue, epoxy, or other similar bonding agent. Any of these features and/or mechanisms can be used in conjunction with or in alternative to the magnetic elements 120 or 122.

In certain embodiments, a seam strip is provided to finish the seam 502. The seam strip can include a cap, a cover, an insert, or the like and can be composed of metal, wood, ceramic, plastic, laminate, rubber, or some other similar synthetic or natural material. The seam strip can be provided in different shapes and forms suited for 30, 45, or 90 degree seams 502. Alternatively, the seam strip can be cut and formed to final shape to accommodate various non-standard or atypical seams 502. The seam strip can be retained in place over the seam 502 using glue, adhesive, epoxy, or some other similar bonding agent. Alternatively, the seam strip 502 can be an insert with apertures that enable the magnetic elements 120 or 122 to couple there through and an exposed seam cover. The seam strip can be used in conjunction with seams defined by adjoining endcaps 116 or sidesplashes 118.

FIG. 6 is a bottom perspective view of a cabinet 606 attachment system of a modular countertop system, in accordance with an embodiment of the invention. In one embodiment, a countertop system kit 100 includes, but is not limited to, a first countertop section 102 composed of a foam core 104 at least partly covered by a laminate layer 106; a plurality of embedded interconnection receptacles 108 within the foam core 104; at least one bottom interconnection receptacle 204 on a bottom surface 114 of the foam core 104; a plurality of 45 and 90 degree cut-line indications 110 on the bottom surface 114 of the first countertop section 102 at positions that correspond to the plurality of embedded interconnection receptacles 108 embedded within the foam core 104, wherein cutting of the first countertop section 102 along any of the plurality of 45 and 90 degree cut-line indications 110 exposes at least one of the plurality of embedded interconnection receptacles 108; at least one first magnetic element 120 having a first three-dimensional mechanical surface pattern 404 that is insertable within the at least one bottom interconnection receptacle 204; and at least one bracket 604 mountable to at least one cabinet 606 and including at least one second magnetic element 122 having a second three-dimensional mechanical surface pattern 406 that is configured for interlocking the first three-dimensional mechanical surface pattern 404 of the at least one first magnetic element 120 inserted within the at least one bottom interconnection receptacle 204 to secure the first countertop section 102 to the at least one cabinet 606.

In certain embodiments, the bottom interconnection receptacle 204 is a cylindrical cutout in the bottom surface 114 of the countertop section 102. The cutout of the receptacle 204 is sized to receive the magnetic element 120 such that the magnetic element is substantially flush with the bottom surface 114 when inserted therein. The receptacles 204 are positioned at various locations on the bottom surface 114 adjacent to the cut line indications 110. The receptacle 204 can be differently sized or shaped, such as square, oval, rectangular, triangular, or other regular or irregular shape. The edges of the receptacle 204 can be tapered or include a tab or flange for securing the magnetic element 120 therein. There can be more or fewer receptacles 204 on the bottom surface 114 and the receptacles 204 can be differently positioned relative to the cut line indications 110.

In certain embodiments, the magnetic element 120 is insertable within any of the bottom interconnection receptacles 204 and may be secured therein using any of the various mechanisms discussed herein with respect to the receptacles 108. This includes, but is not limited to, use of glue, bonding, adhesive, friction, fasteners, threads, or other securing mechanism. The magnetic element 120 can be reversed with magnetic element 122 such that the magnetic element 120 is associated with the bracket 604. Alternatively, the magnetic element 120 or 122 can be differently sized or shaped or have different mechanical surface patterns as compared to the magnetic elements used in association with receptacle 108.

In other embodiments, the bracket 604 is a 90 degree bracket configured for interfacing with the countertop section 102 on one end and a cabinet 606 frame on another end. The bracket 604 can be metal, plastic, wood, rubber, or other natural or synthetic material. The second magnetic elements 122 can be incorporated on each end of the bracket 604 or the magnetic elements 122 can be configured for securing to the bracket 604 using any of the various mechanisms discussed herein with respect to receptacles 108 and 204. These mechanisms include, but are not limited to use of, welding, glue, bonding, adhesive, friction, fasteners, threads, or other securing mechanism. Alternatively, the second magnetic elements 122 can be substituted with magnetic elements 120 or some other magnetic element. For instance, the bracket 604 can be composed of ferrous metal or other magnetically attracting metal and include mechanical surface ridges and/or impressions from interlocking with magnetic elements 120 or 122 associated with the countertop section 102 or cabinet 606. The bracket 604 can employ the magnetic element 122 on one end to couple with the countertop section 102 and fasteners on another end, such as to couple with the cabinet 606.

While preferred and alternate embodiments of the invention have been illustrated and described, as noted above, many changes can be made without departing from the spirit and scope of the invention. Accordingly, the scope of the invention is not limited by the disclosure of these preferred and alternate embodiments. Instead, the invention should be determined entirely by reference to the claims that follow.

1. A countertop system comprising:
a first countertop section composed of a foam core at least partly covered by a laminate layer;
a plurality of interconnection receptacles embedded within the foam core; and
a plurality of cut-line indications on a bottom surface of the first countertop section at positions that correspond to the plurality of interconnection receptacles embedded within the foam core,
wherein cutting of the first countertop section along any of the plurality of cut-line indications exposes at least one of the plurality of interconnection receptacles.

2. The countertop system kit of claim 45, wherein the foam core covers the laminate layer a top side of the first countertop section.

3-13. (canceled)

14. The countertop system kit of claim 45, wherein the plurality of cut-line indications include 30, 45, and 90 degree cut-line indications.

15. The countertop system kit of claim 45, wherein the plurality of 45 and 90 degree cut-line indications are surface indicia.

16. The countertop system kit of claim 45, wherein the plurality of 45 and 90 degree cut-line indications are mechanical surface grooves that at least partially guide a saw.

17. The countertop system kit of claim 45, wherein the first countertop section includes one or more mounting apertures on the bottom surface of the first countertop section at positions that correspond to the plurality of 45 and 90 degree cut-line indications, the one or more mounting apertures being configured to secure a saw guide or rip fence therein.

18. The countertop system kit of claim 45, further comprising:
a rip fence or saw guide configured to mount at one or more positions on the bottom surface of the first countertop section to guide a saw.

19. The countertop system kit of claim 45, wherein the first countertop section includes one or more protrusions on at least one uncut end to interconnect with at least one receptacle element of a second countertop section, endcap, or sidesplash.

20. The countertop system kit of claim 45, wherein the first countertop section includes one or more receptacles on at least one uncut end to receive the one or more second magnetic elements to magnetically interconnect with a second countertop section, the at least one endcap, or the at least one sidesplash.

21-28. (canceled)

29. The countertop system kit of claim 45, wherein the at least one first magnetic element is insertable within at least one of the plurality of interconnection receptacles or one or more receptacles at an uncut end of the first countertop section to magnetically couple with a second countertop section, the at least one endcap, or the at least one sidesplash.

30-31. (canceled)

32. The countertop system kit of claim 45, wherein the at least one endcap or sidesplash includes one or more protrusions for interconnecting with the first countertop section.

33. The countertop system kit of claim 45, wherein the at least one endcap or sidesplash includes one or more receptacles for interconnecting with the first countertop section.

34. (canceled)

35. The countertop system of claim 45, wherein the at least one endcap or sidesplash includes at least one of the one or more second magnetic elements.

36-43. (canceled)

44. A countertop system kit comprising:
a first countertop section composed of a foam core at least partly covered by a laminate layer;
a plurality of interconnection receptacles embedded within the foam core;
a plurality of cut-line indications on a bottom surface of the first countertop section at positions that correspond to the plurality of interconnection receptacles embedded within the foam core, wherein cutting of the first countertop section along any of the plurality of cut-line indications exposes at least one of the plurality of interconnection receptacles;
at least one first magnetic element having a first three-dimensional mechanical surface pattern that is insertable within at least one of the plurality of interconnection receptacles;
at least one sidesplash including one or more second magnetic elements having a second three-dimensional mechanical surface pattern for interlocking with the first three-dimensional mechanical surface pattern of the at least one first magnetic element; and
at least one endcap as a laminate strip with adhesive backing, the at least one endcap having a cross-sectional shape that matches that of the first countertop section.

45. A countertop system kit comprising:
a first countertop section composed of a foam core at least partly covered by a laminate layer;
a plurality of embedded interconnection receptacles within the foam core;
at least one bottom interconnection receptacle on a bottom surface of the foam core;
a plurality of 45 and 90 degree cut-line indications on the bottom surface of the first countertop section at positions that correspond to the plurality of embedded interconnection receptacles embedded within the foam core, wherein cutting of the first countertop section along any of the plurality of 45 and 90 degree cut-line indications exposes at least one of the plurality of embedded interconnection receptacles;
at least one first magnetic element having a first three-dimensional mechanical surface pattern that is insertable within at least one of the plurality of embedded interconnection receptacles;
at least one peg that is insertable within the foam core at a side edge;
at least one sidesplash having at least one edge interconnection receptacle and at least one aperture for receiving the at least one peg;
at least one endcap as a laminate strip with adhesive backing, the at least one endcap having a cross-sectional shape that matches that of the first countertop section;
one or more second magnetic elements having a second three-dimensional mechanical surface pattern for interlocking with the first three-dimensional mechanical surface pattern of the at least one first magnetic element, the one or more second magnetic elements being insertable within the at least one edge interconnection receptacle or the at least one bottom interconnection receptacle; and
at least one bracket mountable to at least one cabinet and including at least one third magnetic element having the first three-dimensional mechanical surface pattern that is configured for interlocking the second three-dimensional mechanical surface pattern of the one or more second magnetic elements inserted within the at least one bottom interconnection receptacle to secure the first countertop section to the at least one cabinet.

46. The countertop system of claim 1, wherein the plurality of interconnection receptacles are embedded within the foam core offset from the cut-line indications between the cut-line indications.

47. The countertop system of claim 1, wherein the plurality of interconnection receptacles are embedded within the foam core offset from the cut-line indications edges in a plurality of discrete positions alone a line parallel to that edge.

48. The countertop system of claim 1, wherein the plurality of interconnection receptacles are embedded within the foam core such that a cut along any of the cut-line indications will expose one or more of the receptacles.

49. The countertop system of claim 1, wherein the plurality of interconnection receptacles are embedded within the foam core such that two are located along each cut-line indication.
